(19) United States
(12) Patent Application Publication
(10) Pub. No.: US 2007/0173562 A1
(43) Pub. Date: Jul. 26, 2007

(54) Concrete embed plate

(76) Inventor: David S. Jablonsky, Manchester, CT (US)

Correspondence Address: R. Scott Kimsey;Sonnenscheim Nath & Rosethal, Sear Tower, Wacker Drive Station, P.O. Box #061080, Chicago, IL, 60606-1080, US

(21) Appl. No.: 11/340,299

(22) Filed: Jan. 26, 2006

(51) Int. Cl. C09J 4/00

(52) U.S. Cl. 523/176

(57) ABSTRACT

The present invention is directed to a concrete embed plate having a body portion and at least one cup portion projecting from the body portion and extending outward and downward therefrom. It is preferred that the body portion and at least one cup portion of the present embed plate are constructed from a single, unitary piece of material.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention is directed generally to an embed plate, and more specifically to a thin embed plate having cup portions along a perimeter thereof.

Structural concrete portions, such as concrete slabs, footings, raft foundations, beams, walls, floors, columns, precast/prestressed concrete components, and the like, are generally able to withstand a good deal of compressive force. These same concrete structures, however, generally react poorly to shear and tensile forces within or applied to the structure. These forces cause cracking or breakage within the concrete portion. Such cracking or breakage may occur internally to the concrete portion and therefore may go unnoticed until the situation becomes serious and the structural integrity of the concrete component or structural system has been compromised.

Concrete embed plates are commonly used to provide strong support for attachment of fixtures or other structures to a structural concrete portion, and to allow such structures to better support applied loads and withstand tensile and shear forces external to the structure, such as from dead loads, wind, seismic forces, live loads, and the like. Such plates may also be used to attach two or more concrete portions to one another. Traditional embed plates include a plate portion and a plurality of studs that extend perpendicularly therefrom. While these embed plates provide some protection against shear forces, under sufficient load shear forces nevertheless result in failure of the concrete at the area of the four studs. Further, traditional embed plates must be relatively thick in order to have sufficient strength to be used for their intended purpose. This leads to a corresponding increase in weight of the concrete structure in which the embed plate is embedded, which may be of concern in construction projects wherein the weight of the finished structure is extremely important (such as with respect to bridges and the like).

The present invention provides, among other things, an embed plate with enhanced shear protection with respect to traditional embed plates, and is at the same time lighter and stronger than a traditional embed plate.

### SUMMARY OF THE INVENTION

The present invention is directed to a concrete embed plate having a body portion and at least one cup portion projecting from the body portion and extending outward and downward therefrom. It is preferred that the body portion and at least one cup portion of the present embed plate are constructed from a single, unitary piece of material.

In an alternative embodiment, the present embed plate preferably includes at least one side portion, which is also preferably constructed from the same unitary piece of material as the body portion. The side portion(s) of the present device preferably include at least one tab, which may be part of the same, unitary material as the side portion or may be constructed from a separate piece of material and attached to the side portion by any suitable mechanism such as, for example, welding. The tab portion further preferably includes an opening adapted to receive a portion of a concrete reinforcing structure such as rebar.

In another embodiment of the present invention, the side portion(s) of the present embed plate preferably include at least one stiffening dart to lend strength thereto.

In still another embodiment of the present invention, the side portion(s) of the present embed plate further include a cutout portion adapted to receive at least a portion of a concrete reinforcing structure.

In yet another embodiment of the present invention, the side portion(s) of the present embed plate further include at least one leg portion extending therefrom along the same plane as the side portion. It is preferred that each leg portion include an opening therein adapted to receive at least a portion of a concrete reinforcing structure.

The various embodiments of the present invention are preferably constructed from steel, but any suitable material, such as other metal alloys, aluminum, titanium, synthetic polymers, carbon fiber, or combinations thereof, may also be used in the construction of the present embed plate.

### BRIEF DESCRIPTION OF THE DRAWINGS

FIG. 1 is a perspective view of one embodiment of an embed plate constructed in accordance with the teachings of the present invention.

FIG. 2 is a top view of the embed plate depicted in FIG. 1.

FIG. 3 is a side elevational view of the embed plate depicted in FIG. 1.

FIG. 4 is a perspective view of an alternative embodiment of an embed plate constructed in accordance with the teachings of the present invention.

FIG. 5 is a perspective view of another alternative embodiment of an embed plate constructed in accordance with the teachings of the present invention.

FIG. 6 is a perspective view of another alternative embodiment of an embed plate constructed in accordance with the teachings of the present invention.

FIG. 7 is a perspective view of another alternative embodiment of an embed plate constructed in accordance with the teachings of the present invention.

FIG. 8 is an elevational view of another alternative embodiment of an embed plate constructed in accordance with the teachings of the present invention.

FIG. 9 is a cross-sectional view of an embed plate constructed in accordance with the teachings of the present invention, the embed plate being shown embedded in a concrete slab.

### DETAILED DESCRIPTION OF THE INVENTION

Turning now to the drawings, wherein like numerals indicate like parts, the numeral 10 refers generally to an embed plate constructed in accordance with the teachings of, and exemplifying, the present invention. In a preferred embodiment, embed plate 10 includes a body portion 12, cup portions 14, and tabs 16, and is preferably constructed from steel, although any suitable material may be used.

FIG. 1 provides a perspective view of one embodiment of an embed plate 10 constructed in accordance with the teachings of the present invention. As shown in FIG. 1, embed plate 10 has a generally square-shaped, flat body 12 having an upper and lower surface. Although shown as being generally square in shape, it is contemplated that body 12 of embed plate 10 may be provided in a variety of shapes and sizes without departing from the present invention. For example, rectangular, triangular, or even circular bodies 12 may be provided that retain the novel features of the present embed plate as described herein. Likewise, various thicknesses of body 12 may be provided, with each thickness chosen to impart sufficient strength to embed plate 10 to render embed plate 10 suitable to a particular application. For uses wherein greater strength is required, for example, a thicker body 12 may be provided with embed plate 10. Alternatively, the materials from which embed plate 10 is constructed may be chosen in order to provide the necessary balance between strength, weight, and corrosive resistance as suitable for particular uses of embed plate 10.

Body 12 of embed plate 10 preferably includes first and second cup portions 14 extending downward therefrom. Cup portions 14 preferably extend from opposing edges of body 12, as shown in FIG. 1. It is contemplated, however, that cup portions 14 may be present along any two edges of body 12 of embed plate 10. Additionally, in some embodiments of the present invention, a single cup portion 14 may be provided, while in other embodiments more than two cup portions 14 may be provided (i.e. three or four cup portions 14 may be provided, each along a separate edge of body 12). Although as shown in the drawings, each of cup portions 14 extends substantially along the entire length of an edge of body 12, it is contemplated that one or more edges of body 12 may be provided having more than one cup portion 14 therealong, each cup portion 14 extending along less than the entire length of an edge of body 12 of embed plate 10.

Cup portions 14 of embed plate 10 are preferably constructed from the same, unitary piece of material from which body 12 is constructed. That is, it is preferred that cup portions 14 are not welded or otherwise attached to body 12 of embed plate 10. While in some embodiments of the present invention such welded or otherwise attached cup portions 14 may be utilized and may be sufficient for a given application of embed plate 10, preferred embodiments constructed from a single, unitary piece of material as described above provide greater strength to embed plate 10. Using a weld or other means of attachment to secure cup portions 14, as separate pieces, to body 12 creates points of weakness that in turn lead to a weaker embed plate 10. While this may be acceptable in certain circumstances, it is not preferred.

As shown in FIG. 1, the opposing edges of body 12 not having any portions 14 therealong preferably have side portions 24 extending downward therefrom. As with respect to cup portions 14, above, it is preferred that body 12 and side portions 24 extending therefrom are constructed from a single, unitary piece of material in order to provide greater strength to embed plate 10. Further, at a point wherein body 12 bends to form side portions 24, stiffening darts 22 are preferably present to lend additional strength to embed plate 10. Stiffening darts 22 serve to prevent springback of the metal used to construct embed plate 10, thus making the bend in embed plate 10 stiffer than it would be in the absence of the darts. Nevertheless, it is contemplated that embed plate 10 may be provided without stiffening darts 22. The length of side portons 24 may vary depending on the particular use to which embed plate 10 is to be put. For example, given relatively shallow or thin concrete structures, side portions 24 are preferably relatively short so that embed plate 10 is easily embedded within the concrete structure without the protrusion of side portions 24 therefrom. Given relatively thick concrete structures, side portions 24 may be longer, providing greater surface area in contact with the concrete and therefore providing greater protection against shear and tensile forces. Such a lengthening of side portions 24, however, also results in a greater overall weight for embed plate 10.

Tabs 16 extend outward from side portions 24 as shown in the drawings, along a plane substantially parallel to the plane of body portion 12 of embed plate 10. Although two tabs 16 are shown in the drawings as being present on opposing sides of embed plate 10, it is contemplated that only one tab 16 may be present along a given side of embed plate 10, or that more than two tabs 16 may be present along a given side. Further, each side of embed plate 10 having tabs 16 need not have the same number of tabs 16. That is, a first side of embed plate 10 may have two tabs 16 present therealong, while a second side may have one tab 16 or more than two tabs 16 present therealong. In addition, tabs 16 may be provided substantially parallel to the plane of body portion 12, as shown in the drawings, or may be provided at an angle thereto, such as a 45 degree angle, for example. It is contemplated that any suitable angle may be used.

As also shown in the figures, tabs 16 may include holes 18 extending through the width thereof. Holes 18 are preferably adapted to receive riveted studs or other structural reinforcing portions therethrough such that embed plate 10 can be utilized along with existing concrete reinforcing structures known in the art. Inclusion of holes 18 provides a mechanism for engagement of riveted studs with embed plate 10 without the need to attach Nelson or welded studs to embed plate 10 by welding or other means. It is contemplated, however, that embed plate 10 may be provided without holes 18.

In use, the top surface of body 12 of embed plate 10 is preferably flush with an outer surface of the concrete structure in which embed plate 10 is embedded. Opening 20 in body 12 is provided for attachment of embed plate 10 to concrete forms during placement and before pouring the concrete in the form and around the plate. The hole is also used to allow air to escape under the plate when concrete moves under the plate. Although a single opening 20 is shown in the figures, it is contemplated that more than one opening 20 may be provided with embed plate 10. In addition to attaching a concrete form to embed plate 10 by means of opening 20, it is further contemplated that a screw or other fastener may be welded to the upper surface of body 12 of embed plate 10 so that attachment to threaded rods may be accomplished at angles other than those allowed by opening 20.

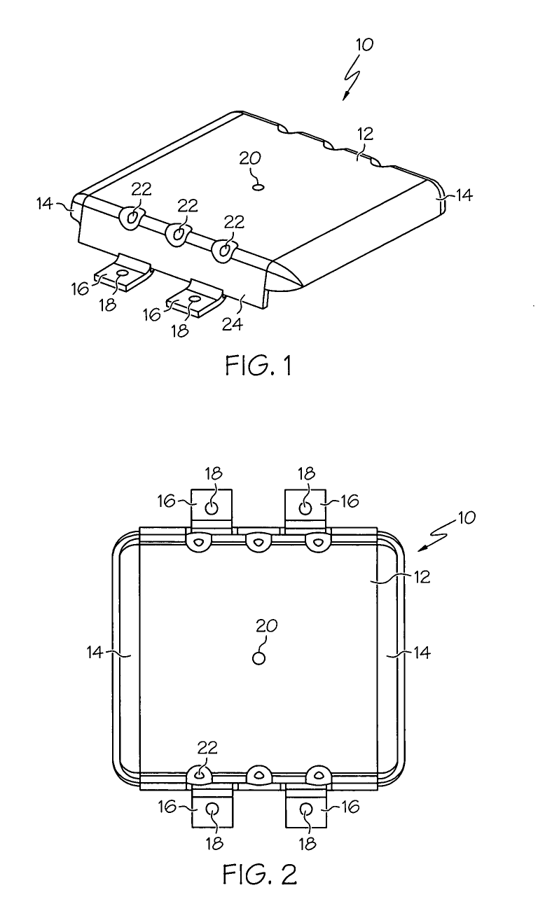

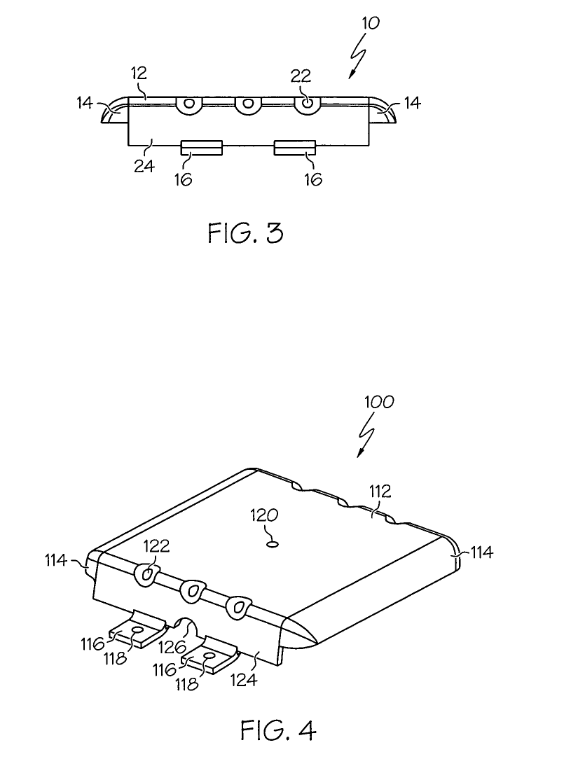

FIG. 2 depicts a top view of one embodiment of embed plate 10. In the figure, tabs 16 on two sides of embed plate 10 are visible. The various portions of the embodiment of embed plate 10 shown in FIG. 2 are as described with respect to FIG. 1, above. Likewise, FIG. 3 provides a side view of embed plate 10, with tabs 16 extending outward in a plane perpendicular to the plane of the paper. The various portions of the embodiment of embed plate 10 shown in FIG. 3 are as described with respect to FIG. 1, above.

FIG. 4 provides a perspective view of an alternative embodiment of an embed plate 100 constructed in accordance with the teachings of the present invention. The portions of embed plate 100 shown in FIG. 4 are substantially the same as those described with respect to embed plate 10, above. For example, embed plate 100 preferably includes a body 112, cup portions 114, side portions 124, and tabs 116, each with features and characteristics as described with respect to the corresponding portions of embed plate 10, above. In addition, however, embed plate 100 includes a cutout 126 along a lower edge of side portions 124. Cutout portion 126 is adapted to receive a reinforcing structure, such as rebar, which can extend under the length of embed plate 100 so that embed plate 100 may rest thereupon. Cutout portion 126 is particularly suited to receive a reinforcing structure known as “u-bar.” Cutout portion 126 preferably sits on a portion of the u-bar that extends into the concrete structure. The stability provided by the mating of the reinforcing structure with cutout portion 126 eliminates the need for welding the reinforcing structure to the embed plate.

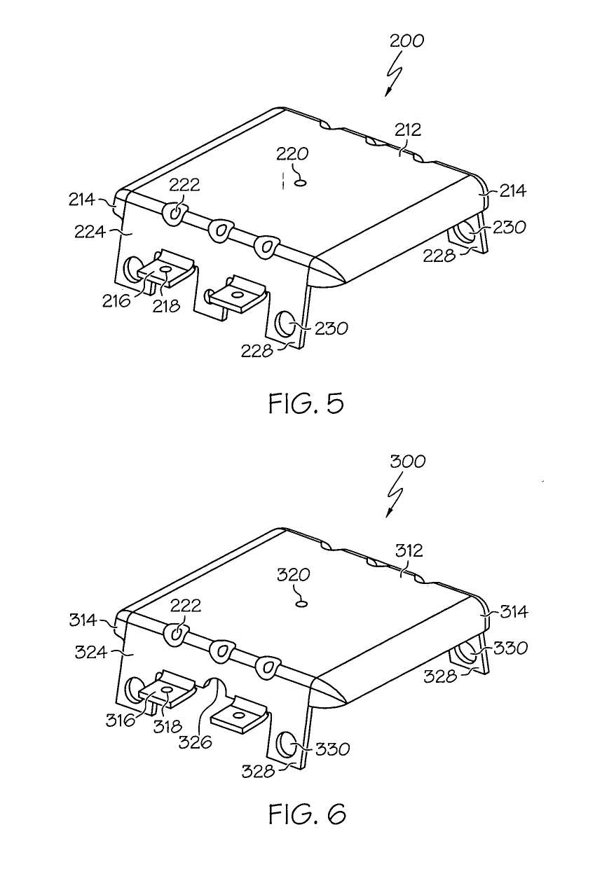

FIG. 5 depicts another alternative embodiment of the present invention—embed plate 200. As with respect to the embodiment of the present invention provided in FIG. 4, the portions of embed plate 200 analogous to embed plate 10 are substantially the same as described above. For example, embed plate 200 preferably includes a body 212, cup portions 214, side portions 224, and tabs 216. Also shown in the embodiment in FIG. 5 are openings 220 and 218. Embed plate 200, however, additionally includes a plurality of leg portions 228 extending downward from side portions 224. Leg portions 228 provide for a greater surface area of embed plate 200 to be in contact with the surrounding concrete when the depth of the concrete allows use of leg portions 228. This provides even greater protection against shear and tensile forces with a concrete structure that includes embed plate 200. In the embodiment of embed plate 200 shown in FIG. 5, embed plate 200 includes six leg portions 228, three on each of two opposing sides of the device. Two leg portions 228 on each side are coextensive with opposing side edges of a side portion 224, whereas the third leg portion 228 extends from substantially the middle of side portion 224, between tabs 216. Each of leg portions 228 preferably contain an opening 230 therein, openings 230 adapted for use with reinforcing structures such as rebar. Although it is preferred that each leg portion 228 contains such an opening 230, it is contemplated that embed plate 200 may be provided with no openings 230, or that some leg portions 228 may include openings 230 whereas others may not. The embodiments of the present invention that include leg portions 228 are generally intended for use in thicker concrete structures than those that do not include leg portions 228. Although the present device is described above, and shown in the figures, as having six leg portions (three on each side thereof), it is contemplate that depending on the size and shape of plate used, greater or fewer than three leg portions may be present on each side of the plate, and in some instances one side of the plate may have a greater number of leg portions than the other.

The embodiment 300 of the present invention shown in FIG. 6 is substantially the same as the described with respect to FIG. 5, above, the key difference being the absence of a middle leg portion extending from each side portion 324. In place of a middle leg portion, embed plate 300 includes cutout portion 326. Cutout portion 326 is adapted to receive a reinforcing structure, such as rebar (particularly u-bar), as described with respect to embed plate 100, above, and shown in FIG. 4. The mating of cutout portion 326 with a reinforcing structure eliminates the need to weld the reinforcing structure to embed plate 300.

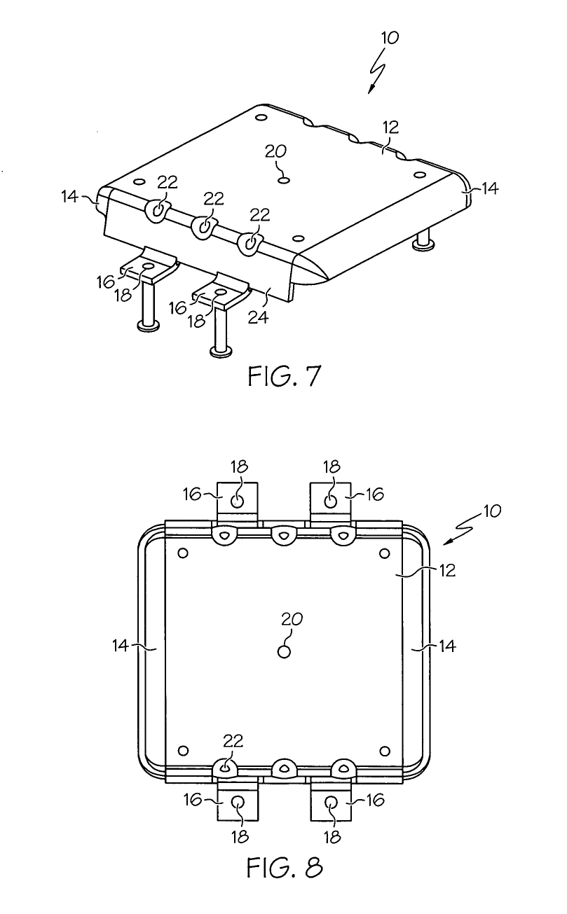

FIGS. 7 and 8 depict another embodiment of the present concrete embed plate, the embodiment shown including openings 26 in body 12 thereof. As shown in the figures, the embed plate has four opening 26, each located substantially at each of the four corners of body 12. It is contemplated, however, that greater or fewer than four openings 26 may be provided, and that the location of opening(s) 26 may be varied across the surface of body 12. It is further contemplated that opening 20 may or may not be included in body 12. Openings 26 are provided for attachment of embed plate 10 to concrete forms during placement and before pouring the concrete in the form around the plate. Openings 26 further allow air to escape under embed plate 10 when concrete moves under the plate.

Also shown in FIGS. 7 and 8 are riveted studs 28, received by openings 18 of tabs 16. It is contemplated that in some embodiments of the present plate, a riveted stud 28 may be inserted in each of openings 18 of tabs 16.

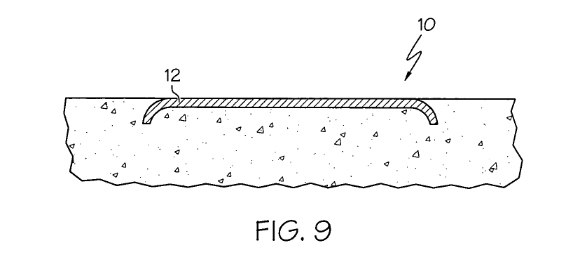

FIG. 9 provides a cross-sectional view of one embodiment of the present concrete embed plate shown embedded in a section of concrete slab. As is clearly shown in the figure, the top surface of the embed plate is flush with the top surface of the concrete slab. It is preferred that the various embed plates of the present invention are positioned in this manner in use, though it is contemplated that the plate may be positioned in any suitable manner, which may vary depending on the particular application for which the plate is being used.

As noted above, it is preferred that the various embodiments of the present invention are constructed from steel. Because of the novel configuration of the present device, as described above, the thickness of steel required to produce the device is less than that of the typical embed plate known in the art. A traditional embed plate is generally ⅜ inches to ½ inches thick, whereas the present device is preferably only ⅛ inch thick at its thinnest thickness. The present device can impart greater strength to the concrete, while remaining thin, because the cup portions of the present device add greater strength to the device, as do the leg portions in embodiments of the present device that include leg portions. These features increase the surface area of the embed plate in contact with the surrounding cement, giving greater protection against shear and tensile forces. For example, in edge pullout shear capacity tests performed using a ⅛ inch embed plate without the novel cup portions of the present device, load failure occurred at 13,659 pounds. When the same test was conducted using a ⅛ inch embed plate that included the novel cup portions of the present invention, load failure occurred at 21,195 pounds. Using rebar in association with the ⅛ inch embed plate of the present invention resulted in load failure occurring only at 23,550 pounds. Thus, the present design allows for greater strength while using less material to construct the embed plate. This results in lighter plates and, correspondingly, lighter concrete structures in which the plates are embedded. Also, the cost of manufacture of the present embed plate is less than that of traditional embed plates because less steel or other material is used.

In addition to steel, any other suitable material may be used. For example, aluminum or aluminum alloys may be used, as may various other metals. It is further contemplated that for some applications various synthetic polymers may be used. Likewise, carbon fiber may be used to construct an embed plate in accordance with the teachings of the present invention, providing for an extremely light-weight, yet strong plate.

In addition to changes in material composition, alterations may be made to the basic structure of the present device without departing from the scope of the invention. As described above, for example, the number and size of the various cup portions may be altered. Likewise, the number and size of the various leg portions or tabs may be altered as needed for a given application. In addition, ridges may be provided along the various surfaces of the embed plate that are shown in the drawings as smooth surfaces. The addition of such ridges further increases the surface area of the device in contact with the surrounding concrete and further protects against shear forces. It will be readily apparent to those of skill in the art, upon reading this disclosure, that many other modifications may be made to the present invention.

Although numerous advantages and characteristics of the present invention have been described herein, together with details concerning the structure and function of the invention, the foregoing description is exemplary only. Accordingly, changes may be made in detail, particularly in matters of shape, size, arrangement of features, and materials of the present invention while still remaining within the broad spirit and scope of the invention. It is intended that the scope of the invention be limited only by the claims that follow.

What is claimed is:

1. A concrete embed plate comprising:
a body portion having an upper and lower surface, a thickness, a length, and a width, wherein the length and width of said body portion are greater than the thickness thereof; and
at least one cup portion extending from to said body portion.

2. The embed plate according to claim 1 wherein said body portion and said at least one cup portion are constructed from a single, unitary piece of material.

3. The embed plate according to claim 1 wherein said body portion comprises at least one opening in said upper surface thereof and extending through a thickness thereof.

4. The embed plate according to claim 1 further comprising at least one side portion fixedly attached to said body portion and extending downward with respect to an upper surface thereof.

5. The embed plate according to claim 4 wherein said body portion and said at least one side portion are constructed from a single, unitary piece of material.

6. The embed plate according to claim 4 further comprising at least one tab projecting from said at least one side portion and extending away therefrom.

7. The embed plate according to claim 6 wherein said at least one tab and said at least one side portion are constructed from a single, unitary piece of material.

8. The embed plate according to claim 6 wherein said at least one tab is fixedly attached to said at least one side portion by welding.

9. The embed plate according to claim 4 wherein said at least one side portion further comprises at least one leg portion extending therefrom in substantially the same plane as said at least one side portion.

10. The embed plate of claim 4 wherein said at least one side portion further comprises at least one stiffening dart formed in an upper surface thereof.

11. The embed plate of claim 6 wherein said at least one tab further comprises at least one opening adapted to receive at least a portion of a reinforcing anchorage mechanism.

12. The embed plate of claim 9 wherein said at least one leg portion further comprises at least one opening adapted to receive at least a portion of a concrete reinforcing structure.

13. The embed plate of claim 4 wherein said at least one side portion further comprises a cutout portion along a side edge thereof, said cutout portion being adapted to receive at least a portion of a concrete reinforcing structure.

14. The embed plate of claim 1 wherein said embed plate is constructed from a material selected from the group consisting of steel, stainless steel, aluminum, titanium, galvanized steel, metal alloy, carbon fiber, and combinations thereof.

15. A concrete embed plate comprising:
a body portion having an upper and lower surface, a thickness, a length, and a width, wherein the length and width of said body portion are greater than the thickness thereof;
two cup portions projecting from said body portion, each said cup portion extending from an opposing edge of said body portion and extending outward with respect to said body portion, each said cup portion further extending downward with respect to an upper surface of said body portion;
two side portions projecting from said body portion, each said side portion extending from an opposing edge of said body portion other than said opposing edges from which said cup portions extend, each said side portion extending downward with respect to an upper surface of said body portion;
wherein each said side portion further comprises at least one tab projecting therefrom and extending away therefrom.

16. The embed plate according to claim 15 wherein each said side portion further comprises at least one stiffening dart formed in an upper surface thereof.

17. The embed plate according to claim 15 wherein each of said body portion, said two cup portions, said two side portions, and said at least one tab portion is constructed from a single, unitary piece of material.

18. The embed plate according to claim 15 wherein each of said body portion, said two cup portions, and said two side portions is constructed from a single, unitary piece of material, and further wherein said at least one tab portion is attached to each said side portion by welding.

19. The embed plate according to claim 15 wherein said at least one tab portion further comprises at least one opening adapted to receive at least a portion of a reinforcing anchorage mechanism.

20. The embed plate according to claim 15 wherein said body portion comprises at least one opening in said upper surface thereof and extending through a thickness thereof.

21. The embed plate according to claim 15 wherein said embed plate is constructed from a material selected from the group consisting of steel, stainless steel, aluminum, titanium, galvanized steel, metal alloy, carbon fiber, and combinations thereof.

22. The embed plate according to claim 15 wherein said side portions further comprise at least one cutout portion along an edge thereof, said cutout portion adapted to engage at least a portion of a concrete reinforcing structure.

23. A concrete embed plate comprising:
a body portion having an upper and lower surface, a thickness, a length, and a width, wherein the length and width of said body portion are greater than the thickness thereof;
two cup portions projecting from said body portion, each said cup portion extending from an opposing edge of said body portion and extending outward with respect to said body portion, each said cup portion further extending downward with respect to an upper surface of said body portion;
two side portions projecting from said body portion, each said side portion extending from an opposing edge of said body portion other than said opposing edges from which said cup portions extend, each said side portion extending downward with respect to an upper surface of said body portion;
wherein each said side portion further comprises at least one tab projecting therefrom and extending away therefrom,
and further wherein each said side portion further comprises at least one leg portion extending therefrom in substantially the same plane as each said side portion.

24. The embed plate according to claim 23 wherein each said side portion further comprises at least one stiffening dart formed in an upper surface thereof.

25. The embed plate according to claim 23 wherein each of said body portion, said two cup portions, said two side portions, and said at least one tab portion is constructed from a single, unitary piece of material.

26. The embed plate according to claim 23 wherein each of said body portion, said two cup portions, and said two side portions is constructed from a single, unitary piece of material, and further wherein said at least one tab portion is attached to each said side portion by welding.

27. The embed plate according to claim 23 wherein said at least one tab portion further comprises at least one opening adapted to receive at least a portion of a reinforcing anchorage mechanism.

28. The embed plate according to claim 23 wherein said body portion comprises at least one opening in said upper surface thereof and extending through a thickness thereof.

29. The embed plate according to claim 23 wherein said embed plate is constructed from a material selected from the group consisting of steel, stainless steel, aluminum, titanium, galvanized steel, carbon fiber, and combinations thereof.

30. The embed plate according to claim 23 wherein said side portions further comprise at least one cutout portion along an edge thereof, said cutout portion adapted to receive at least a portion of a concrete reinforcing structure.

31. The embed plate according to claim 23 wherein said at least one leg portion comprises at least one opening therein, said at least one opening adapted to receive at least a portion of a concrete reinforcing structure.

32. The embed plate according to claim 23 wherein said at least one tab includes an opening extending therethrough.

33. The embed plate according to claim 32 further comprising a riveted stud removably attached to the opening extending through said at least one tab.
